(19) United States
(12) Patent Application Publication
(10) Pub. No.: US 2026/0163499 A1
(43) Pub. Date: Jun. 11, 2026

(54) Quantum Energy From Artificially Created Ball Lighting

(71) Applicant: George STANTCHEV, Phoenix, AZ (US)

(72) Inventors: George STANTCHEV, Phoenix, AZ (US); Kiril CHUKANOV, Salt Lake City, UT (US)

(21) Appl. No.: 18/772,312

(22) Filed: Jul. 15, 2024

Related U.S. Application Data
(60) Provisional application No. 63/527,003, filed on Jul. 15, 2023.

(51) Int. Cl. H02N 1/06

(52) U.S. Cl. CPC H02N 1/06

(57) ABSTRACT

The present invention relates to the generation and/or production of energy, and in particular, to the generation and/or production of quantum energy derived from ball lightning produced within a controlled environment.

### CROSS-REFERENCE TO RELATED APPLICATIONS

This application claims an invention which was disclosed in Provisional Application Number 63/527,003, filed Jul. 15, 2023, entitled “Quantum Energy from Artificially Created Ball Lightning” . The benefit under 35 USC § 119(e) of the United States provisional application is hereby claimed, and the aforementioned application is hereby incorporated herein by reference.

### FIELD OF THE INVENTION

The invention describes various practical embodiments and energy generation methods from artificially created ball lightning considered in the present invention.

### BACKGROUND OF THE INVENTION

At least one specification heading is required. Please delete this heading section if it is not applicable to your application. For more information regarding the headings of the specification, please see MPEP 608.01(a).

Ball lightning exhibits extraordinary quantum characteristics. It can be considered a giant macro-atom that generates quantum energy directly into electricity. The nucleus of this macro-atom maintains a constant quantum temperature that remains unchanged even under intense core cooling. Upon its sudden formation, this gigantic nucleus, similar to a normal atomic nucleus, releases nuclear positive energy. The nucleus of the ball lightning “cuts” or annihilates the space at its point of appearance, dramatically increasing the pressure on the surrounding material.

Experimental evidence shows that ball lightning, referred to as a “quantum macro-object” by the authors, is created through rapid and complete ionization of a material medium (gas or liquid), causing a vast number of atoms to ionize simultaneously. In these ionized atoms, the distance between neighboring ions is smaller than the quantum constraints required for a trimeric material object composed of individual ions. Thus, the quantum object created is not a plasma or “plasmoid.”

The quantum macro-object, known as the “ball lightning core,” forms a two-dimensional closed circuit (manifold) that is not composed of individual ion particles but represents a material continuum where the ions have “melted” into a whole, losing their individuality. This two-dimensional (2-D) quantum object has only a surface without interior volume. In fact, there is neither space nor material substance below the closed surface. Let's call it a “black hole”. This “black hole” differs from the cosmological concept of a “black hole”, a term accepted by official science for objects with internal space and structure, into which matter and energy enter but nothing exits.

Electrons from the ball lightning's extremely hot core (thousands of degrees Celsius) plasma transform into a simple electron plasma of individual “free electrons,” not quantum bound to the quantum macro-object. Another fraction of electrons from the initial electron plasma quickly (in about 10-6 seconds) transforms into a three-dimensional (3-D) structureless quantum electron cloud enveloping the newly formed 2-D ball lightning core.

The quantum electrons in this cloud obey the quantum Pauli principle. In their normal state, these electrons are not individual entities but are characterized/manifested by collective motion and behavior. Under external influence, quantum electrons can become individual. For example, when an electric current is applied to the ball of lightning, the quantum electrons become individual carriers of electric charge, obeying the Pauli principle.

When observed, the nucleus and the electron cloud of ball lightning (quantum macro-object) are visible to the human eye. The electron quantum cloud often appears as an orange halo (depending on the temperature of the ball lightning), while the core is bright white, light blue, green, etc. Unlike the halo-electron cloud, the core has clearly defined boundaries and typically takes a spherical shape. However, intense movement in the surrounding environment can transform ball lightning into a shapeless, rapidly changing configuration that resembles a flame of fire.

### SUMMARY OF THE INVENTION

The present invention describes devices and methods for generating energy using artificially created ball lightning. In one embodiment, ball lightning is produced in an enclosed space (such as a chamber or cylinder) through a high-voltage pulse discharge from a battery of powerful high-energy capacitors. The medium for creating ball lightning can be either a gas (such as air) or a liquid (such as a liquid electrolyte or water). Ball lightning annihilates and destroys space at its core's location, compressing the medium against the walls of the vessel. Tremendous pressure arises in the medium of existence of ball lightning.

This pressure generates kinetic quantum energy. The quantum energy has no primary source; it is generated as a result of a quantum effect, the annihilation of space occupied by the ball lightning core. This energy is not merely the transformation of electrical energy from the capacitors. Therefore, the process efficiency as the ratio of the kinetic energy output to electrical input energy is incorrect. In fact, the efficiency of the process, defined as the ratio of output energy to input energy, may be infinite. It is more accurate to consider the efficiency of the process as the ratio of output energy to electrical input, but this ratio does not represent the real efficiency of the process.

The generated quantum energy can be utilized in various applications, including kinetic energy for pistons in cars and other transportation means, launching projectiles and rockets, powerlifting, desalinating seawater, purifying industrial and domestic waste, producing quantum energy, manufacturing large diamonds, creating quantum computers, developing super-powerful lasers, and constructing fuelless quantum rocket engines. It can also be converted to electrical energy.

Although the term “ball lightning” is used herein, it should be understood by those skilled in the art that this artificially created extraordinary object is not necessarily identical to naturally occurring ball lightning. The authors of this invention propose the more general term “quantum material macro-object.” The concepts presented in this invention represent a new paradigm in the field of science and technology.

Extensive experiments on laboratory installations and generators created by the authors have been conducted and analyzed on this new, paradigm-shifting fundamental physics. This research reveals the extraordinary properties of the “quantum material macro-object.” Under certain specially created quantum conditions, these objects may violate the laws of conventional physics. These violations can be practically exploited to generate quantum energy, produce macro-nuclear energy, propel ships and space objects without fuel, create quantum computers, and numerous other revolutionary practical applications.

### BRIEF DESCRIPTION OF DRAWINGS

The brief description of the figures with the general numbering of the elements of the practical applications of the methods considered in the invention is presented by schematic illustrations of various aspects of the methods and apparatus, without limitation of the possible variants of these methods, without unnecessary details unrelated to the essence of the protected by the author claims.

FIG. 1 shows the “quantum world boundaries” and an explanation of how they account for the existence of such ephemeral two-dimensional objects as ball lightning.

FIG. 2 is a schematic illustration of the first embodiment of the invention.

FIG. 3 is a schematic illustration of another embodiment for a system to generate electrical energy.

FIG. 4A is a schematic illustration of the second embodiment that creates artificial ball lightning in another aspect, “underwater” ball lightning.

FIG. 4B is a similar schematic illustration of the second embodiment that creates artificial ball lightning in another aspect, “underwater” ball lightning.

FIG. 5 is a schematic illustration of another embodiment of a system for generating kinetic quantum energy using a mechanism for converting sequential motion into rotational motion. FIG. 6 is a schematic illustration of another embodiment for the generation of kinetic quantum energy and its secondary conversion into electrical energy.

FIG. 7 is a schematic illustration of the generation of quantum energy and its conversion by a “tesla turbine” into the rotary motion of a shaft.

FIG. 8 is a schematic illustration of another embodiment for generation of kinetic quantum energy and its use for launching heavy objects: projectiles, rockets.

FIG. 9 is a schematic illustration of another embodiment for generating kinetic quantum energy in another aspect. Using two ball lightning generation chambers operating in unison. It is used to generate electrical energy by transforming kinetic energy into electrical energy by using electromagnetism.

FIG. 10 is a schematic illustration of another embodiment for a fuelless quantum engine for propulsion of marine vessels.

FIG. 11 is a schematic illustration of another embodiment for seawater desalination systems that use the high pressure created in the water by the occurrence of artificial ball lightning.

FIG. 12 is a schematic illustration of another embodiment for creating a “super-dense” plasma generating quantum energy in the form of heat.

FIG. 13 is a schematic illustration of another embodiment for a fuelless self-sustaining quantum rocket propulsion engine.

FIG. 14 is a schematic illustration of another embodiment for a fuelless self-sustaining quantum engine with 2 pistons.

FIG. 15 is a schematic illustration of another embodiment for a fuelless self-sustaining quantum engine with 2 pistons.

### DETAILED DESCRIPTION OF THE INVENTION

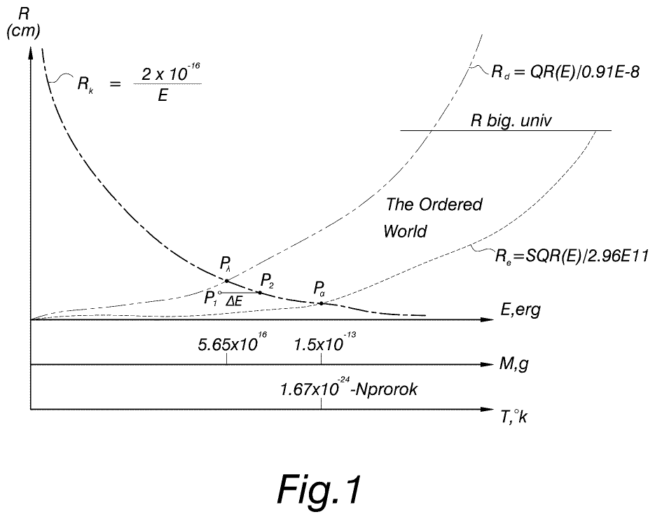

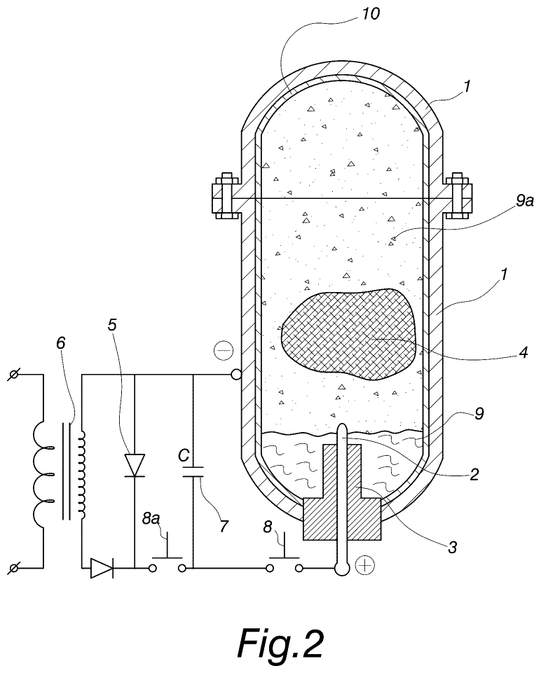

In a series of experiments with quantum macro-objects (artificial ball lightning) conducted over more than three decades, the authors have definitively proven that the physical laws applicable to ordinary three-dimensional material bodies can be violated under certain special quantum conditions for these exotic two-dimensional quantum material bodies. These conditions are explained in FIG. 1 and are essential for implementing the present invention.

According to the inventors, there are limits within which the ordered world exists, and those limits are defined by the smallest and largest stable objects in the universe. The curve of Rk defines the limit on the left imposed by the smallest building brick of the universe-the proton. The size of a proton and the energy of a proton at rest define the Re the minimum proton energy limitation, and Rd defines the maximum proton energy limitation. The ordinary world is limited on the top from the largest stable objects in the universe Rbig.univ. Within these quantum limits, the ordered world exists, and understanding these limits is essential for the mechanics of the present invention.

The inventors have discovered a “quantum realm of existence of discrete matter” (see FIG. 1). Discrete matter is matter made up of individual particles that exist for a long time and may convert between states. This stability allows these material objects to exist in our three-dimensional world of individual things. These are the material objects that surround us and which we perceive and measure as reality with our senses. Quantum two-dimensional material objects, such as ball lightning, present a different picture. They are very ephemeral, appearing for a short time and then disappearing, almost like ghostly objects in our normal three-dimensional world. In this realm, two-dimensional quantum objects are not stable.

After a short existence, these objects jump to the quantum boundary of the stable existence zone of matter (see FIG. 1). This jump is accompanied by a gain of energy, referred to as “delta E.” The jump occurs right at the quantum boundary Rk, where the quantum gain delta R is minimal. This occurs because there is a quantum principle of minimum effect in nature. For example, a water drop with a small weight (negligible influence of gravity) always assumes a spherical shape because this shape minimizes the surface energy of the drop.

In the case of quantum kinetic energy, another quantum effect prevails: the ball lightning core “cuts” the space at the place of its appearance in our three-dimensional world.

The energy in ball lightning is positive and is emitted outward as photon radiation. During the generation of ball lightning, a powerful emission of photons with different energies is observed: light, ultraviolet, X-ray, and gamma photons. The energy of these photons depends on the size of the lightning and its density. The extreme energy of radiation is that of micro-atomic nuclei: kilo-or gigahertz electron-volt photons.

The emission of these photons occurs in a very short time, for example, in microseconds, and is not noticeable as a thermal effect in single pulses. However, if the pulses are of high frequency and occur over a long period, i.e., continuously, the total nuclear macro-energy can significantly contribute to the formation of kinetic energy. In extremely dense ball lightning created with a very high-energy discharge current from the capacitor battery (hundreds or thousands of powerful capacitors), the output quantum nuclear energy can cause a very powerful explosion.

The detailed description of the various variants of the method does not exclude the existence of other practical applications of the method explained here. The explanation of the variants under consideration contains specific details, the main purpose of which is to present features of the technology that are comprehensible within the context of the invention. The quantum macro-object is created in a closed metal (or other strong material) chamber (1) using a discharge of electrical energy accumulated in sufficiently powerful capacitors. See FIG. 2.

FIG. 2 illustrates the main practical application/embodiment of the kinetic quantum energy/pressure generation method. Ball lightning is created in the closed metal chamber (1), which is made of strong stainless steel and is preferably covered from the inside with a layer of dielectric (10): glass, enamel, Teflon, etc. An positive electrode (2) (such as copper, tungsten, or similar) is installed centrally at the lower end of the closed metal chamber (1), which is an electrically isolated part (3) of the closed metal chamber (1). The electrical insulation material can be Teflon, ceramic, glass, or other good electrical insulation material.

The volume of the closed metal chamber (1) is filled with liquid medium (electrolyte) (9) so that the tip of the positive electrode (2) extends above the surface of the electrolyte from 0 to a maximum of 20 mm. The positive electrode (2) must be electrically isolated from the liquid electrolyte along its entire length, exposing only the head of the electrode. In this embodiment, ball lightning is created in a gas environment. Inert gases are more easily ionized, and better results are obtained if the gas medium is under pressure. Air is also a good gas medium for creating a power output efficient ball lightning.

The high-energy capacitor (7) has been charged by a rectifier (5) with grid power (6) to its full capacity, for example, 20 kV. During that time, a first switch (8) is open, and a second switch (8a) is closed. When the high-energy capacitors (7) are fully charged, the second switch (8a) opens and the first switch (8) closes for a very short time, for example, 2.5 ms, and the discharged current flows through the positive electrode (2) via the closed metal chamber (1). the closed metal chamber (1) can be a stainless steel vessel, The dielectric layer (10) with an isolating glass, polymer, ceramic layer, etc. The rectifier (5) can be a half-or full-wave rectifier or a more sophisticated DC current rectifier.

High-energy capacitors (7) discharge the electrical energy stored in them into a gas (9a) or liquid medium (9) through the positive electrode (2) of the electrically isolated part (3). The gas (9a) or liquid medium (9, such as electrolyte) must be suitable for the formation of a ball lightning (4), also called a quantum material macro-object. Among the gases (9a), inert gases are the most suitable for this purpose. If the closed metal chamber (1) is sufficiently sealed, these gases can be used indefinitely because they are not a fuel but only the medium for the existence of this quantum object. Air is also very good for creating ball lightning.

In the first embodiment, the high-energy capacitor (7) can be a capacitor bank, a high-voltage battery, or an electronic power source with low internal resistance, allowing high voltage and high current discharge through the closed metal chamber (1) and the positive electrode (2), polarizing and ionizing the liquid medium (9) in the closed metal chamber (1). Given the above, the high-energy capacitor (7) can be referred to as a more sophisticated instrument collectively known as a pulse generator.

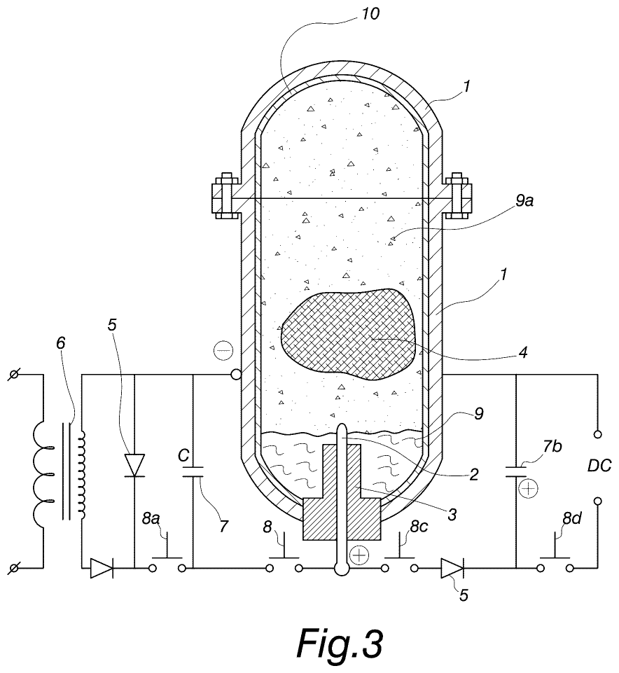

The liquid medium (9) should be a light electrolyte. If the electrolyte is strong or highly conductive, almost all the energy from the capacitors transits through it and only a small fraction of the energy goes into creating ball lightning. This is also dangerous for the capacitors because the transit current flows back into them and may burn them, thus needing protection. The returned energy can be harvested back according to FIG. 3. The inventors recommend slightly diluted seawater as an electrolyte (9) (a very weak electrolyte).

The discharge current from the high-energy capacitor (7) hardly passes through the light electrolyte, but the high voltage does the job, and much of this current going towards creating the ball lightning (4). If the liquid medium (9) is too dilute, as pure water, then the discharge current cannot penetrate the electrolyte and the capacitors remain undischarged. Seawater, as well as air, are free and unlimited sources and very good electrolytes.

The energy of the discharge current from the capacitors goes to heat losses in the first switch (8), ionization of the liquid medium (9) without creating ball lightning, ionization of water in the electrolyte (9) creating ball lightning, and the current passing through the electrolyte and returning to the capacitors. After the collapse of the ball lightning, the energy from the recombination of atoms is converted into heat energy, heating the electrolyte. The energy of the capacitors does not contribute to the output energy generated by the ball lightning. This energy is quantum energy, due to the quantum properties of the “quantum material macro-object.”

At the same discharge current from the capacitors, the magnitude of the output quantum energy depends on the strength of the electrolyte and the volume and configuration of the closed metal chamber (1). The denser the ball lightning (4) (smaller volume), the greater the output quantum energy. This volume has a limit; with a very small closed metal chamber (1), ball lightning may not develop at all.

The life of ball lightning in the closed metal chamber (1) is very short—a few milliseconds, for example, 2.5 ms (recorded clearly with a fast video camera). This short life is mainly due to leakage of electrical discharges through the walls of the metal chamber and the metal electrodes back into the capacitors. To prolong the existence of the ball lightning (resulting in a larger quantum energy output), it is desirable that the internal walls of the closed metal chamber (1) are electrically insulated, such as with a layer of glass enamel or Teflon.

The rise in temperature in the closed metal chamber (1) is negligible after each discharge of each capacitor, increasing by around 0.5 to 1° C. The rise in temperature of the electrolyte is due to the recombination of atoms, the release of nuclear energy in the formation of ball lightning, and the very high quantum temperature of the ball lightning core. The highly delayed picture of the process shows a very strong light at the moment of the appearance of the ball lightning (due to nuclear macro-energy), followed by strong evaporation of water in direct contact with the core of the ball lightning.

In continuous mode (discharging the capacitors at high frequency), this additional thermal quantum energy can be highly sensitive. It must be absorbed as useful thermal energy, especially with very dense ball lightning. For the kinetic quantum energy generation process to proceed normally, this accompanying thermal quantum energy must be removed (cooled) outside the closed metal chamber (1).

The embodiment in FIG. 2 can be further reviewed and optimized to harvest the generated current from the ball lightning, as shown in FIG. 3. The energy harvested is the rectifier (5) and collected in a secondary capacitor (7b) with higher capacity and voltage when a third switch (8c) is closed and the first switch (8) is open. Furthermore, the voltage collected in the secondary capacitor (7b) can be discharged through a DC load connected to a fourth switch (8d).

The discharge current needed for the creation of the ball lightning is short, for example, 2.5 ms, created from the amplitude of the voltage from the capacitor, for example, up to 20 kV. Although the reverse current after the ball lightning discharge has a longer duration, for example, up to 7 ms, and the amplitude of the voltage can be up to 100 kV, charging more powerful storage capacitor banks (7b). Additionally, a portion of that current can be used to recharge the high-energy capacitor (7) and make the process self-sustainable. Refer to FIG. 3 for the general schematic of the second embodiment.

It is understood that there is no known conventional method for the generation of such powerful kinetic energy in a gas or liquid when an electric current is applied to it. All known processes of generating kinetic energy in a gas or liquid medium (in a closed container), such as steam generators, chemical reactions (combustion), nuclear reactions, and heating with an electric current passing through the medium, first pass through the stage of heat generation. No significant output of instantaneous generation of kinetic energy, heat, electricity, or photon radiation (commensurate with the amount of energy input) has been observed in these processes.

The output energy is not the result of converting the input primary electrical energy of the capacitors into the kinetic energy of the electrolyte. It is the result of a quantum effect valid only for quantum objects, in the case of the “cutting/annihilation” of space in the location/volume of the ball lightning appearance. In parallel, the quantum effects of “macro-nuclear energy,” “constant quantum temperature of the ball lightning core,” and pulse generation of energy due to the effect of super-dense quantum plasma also contribute to the output quantum energy. In this process, quantum output energy is generated.

The kinetic quantum energy generated in the process considered in the invention (in its various practical embodiments) can be transformed using various conventional and non-conventional methods (considered in the present invention) into other forms of energy useful for practical purposes, such as electrical energy, energy of motion for transportation, heat, and pressure.

When discussing mechanical engine applications, unlike the general energy in internal combustion engines (mini-explosions, expansion only), the quantum energy in the closed metal chamber (1) works in both directions: 1. The piston moves forward, in the opposite direction of the closed metal chamber (1) (expansion stage, explosion) as a result of the annihilation of space at the point of occurrence of the ball lightning, and 2. The piston moves and does useful work in the opposite direction (contraction, implosion stage) as a result of the huge vacuum created when the ball lightning disappears. Internal combustion engines only do useful work in an explosion and lose work in an implosion.

On the other hand, the ball lightning generation process is symmetric in another respect. Experiments show that in the case of the chamber-cylinder equipped with only one working piston, when the ball lightning disappears, a new source of quantum energy is triggered: the camera jumps like a “frog” in the direction of the explosion of the piston (up), which cannot be explained only by the collapse of the space. This unusual quantum phenomenon has another explanation, which will be shown below.

The role of the chamber volume and its configuration in the magnitude of the output quantum energy has already been mentioned. The best energy effect is obtained when the surface of the ball lightning in contact with the working piston is maximally large. In that case, the ball lightning is flattened like a pancake. However, flattening has its limit, beyond which ball lightning may not appear at all. This problem has been well studied by the inventors both practically and theoretically. Unlike normal three-dimensional bodies, ball lightning does not maintain the triple-point rule for the volume of the vessel.

For example, for a given pressure in a gas/liquid chamber and at different piston diameters, the pressure of the gas leaving the gas/liquid chamber in the piston is greater, the smaller the diameter of the piston. For a quantum material macro-object like ball lightning, this rule does not apply. The pressure at any point/surface area of the piston in contact with the ball lightning is the same regardless of the diameter of the piston. In other words, a piston with the largest possible diameter can be used.

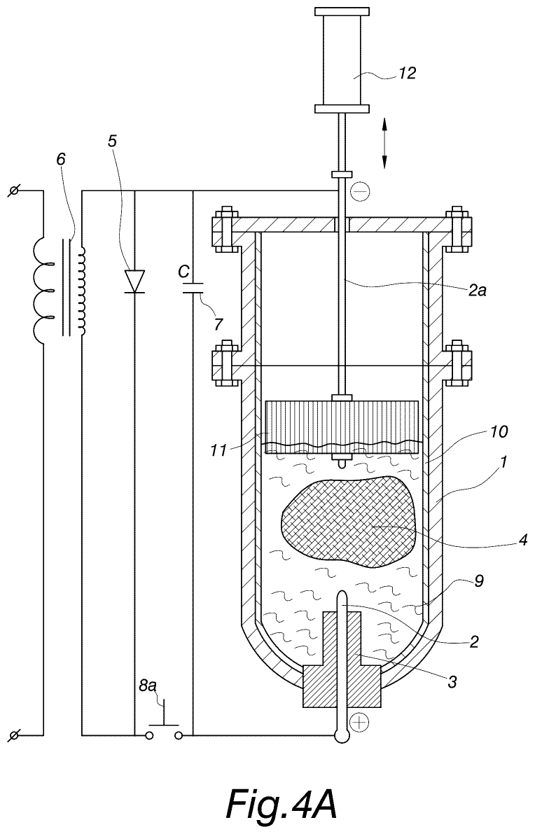

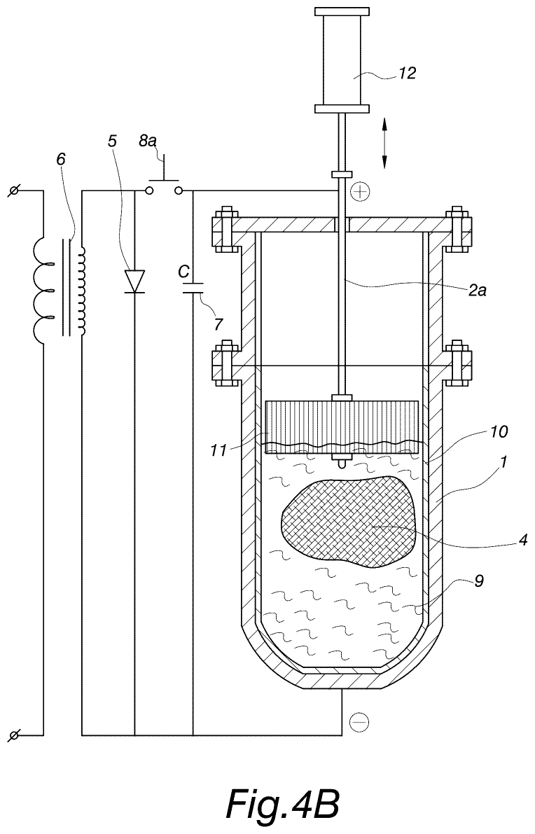

In another embodiment shown in FIG. 4, the volume of the closed metal chamber (1) is completely filled with liquid medium (9). the ball lightning (4) is created “underwater.” The liquid medium (9) is preferably water-based, such as seawater or various concentrations of seawater. It is not necessary for the liquid electrolyte to be under pressure; the results are the same at a pressure of 1 atm and at a pressure of 100 atm, for example. This is because liquids are incompressible; therefore, the distance between two adjacent water molecules does not change with pressure.

In the embodiment shown in FIG. 4, the discharge current from the capacitors is supplied as follows: the positive electrode (2) is connected to the positive pole of the high-energy capacitor (7), and the closed metal chamber (1) is connected to the negative pole. The discharge current from the capacitors is supplied in short pulses with a frequency of several seconds. The strength of a single pulse can reach enormous values: hundreds or millions of amperes. It is the current that ionizes the liquid medium (9). The voltage is important for the breakdown of the current through the liquid medium (9). The higher the voltage of the discharge current, the greater the percentage of ions that make up the ball lightning, the denser it is, and the greater the output of quantum energy.

It is not necessary to use resistance in the path of the current charging the capacitors because the capacitors have their own internal resistance. Additionally, an artificially installed resistance, either active or reactive, in the path of the discharge current does not save the capacitors from burning if they withstand a large discharge current. They withstand hundreds of thousands of amps when discharged. The high-energy capacitor (7) may be a bank of series and parallel configurations. If mounted in parallel, the high-energy capacitor (7) can withstand millions of amperes when discharged.

The positive core of ball lightning represents a material 2-D (two-dimensional) electrical-material continuum. This means that the individual positive ions of the electrolyte at the moment of ball lightning creation, a millionth of a second after the discharge current has flowed, lose their identity, “melt” into one whole, and become a two-dimensional quantum object. It is very important that the ionization of the liquid medium (9) occurs simultaneously for a large number of water molecules. This condition ensures the “bulk ionization” of a large number of water molecules.

Another embodiment of the ball lightning chamber is shown in FIG. 4A, with the positive electrode (2) and a dynamic second electrode (2a). Although simple in implementation, the invention from FIG. 2 has a major drawback in the first switch (8). In addition, the contacts connecting the electrical capacitors with the circuit leading to the electrodes of the closed metal chamber (1) wear out quickly due to the very strong discharge current, hundreds of thousands of amperes.

In the embodiment from FIG. 4A, a new way of commutation is proposed, where the first switch (8) (connecting the capacitors to the closed metal chamber (1)) and the creation of the ball lightning itself become a single process. This is a significant improvement in the energy generator and is an important element in the invention. When the automation of the process signals to empty the capacitors, the dynamic second electrode (2a) “shoots” down with the help of a fast switch controlled by a pneumatic/hydro cylinder (12), and the tip of this electrode enters the liquid medium (9). An electrical connection is made between the two electrodes through the liquid electrolyte.

Very similar to the embodiment shown at FIG. 4A is the embodiment shown at FIG. 4B. At FIG. 4B the positive and negative electrodes are replaced by removing electrode (3) and feeding the negative electrode to the body of the chamber. This way the positive electrode is fed to the dynamic electrode (2a) simplifying the chamber construction significantly. The positively charged capacitor (7) discharges in the liquid (9) at the time the dynamic electrode (2a) touches the liquid surface. This action forms the ball lightning (4). The piston (11) is not mandatory in this case as the ball lightning will expand the liquid with its volume and the liquid will create an action to either a turbine or a piston as already explained in the present invention.

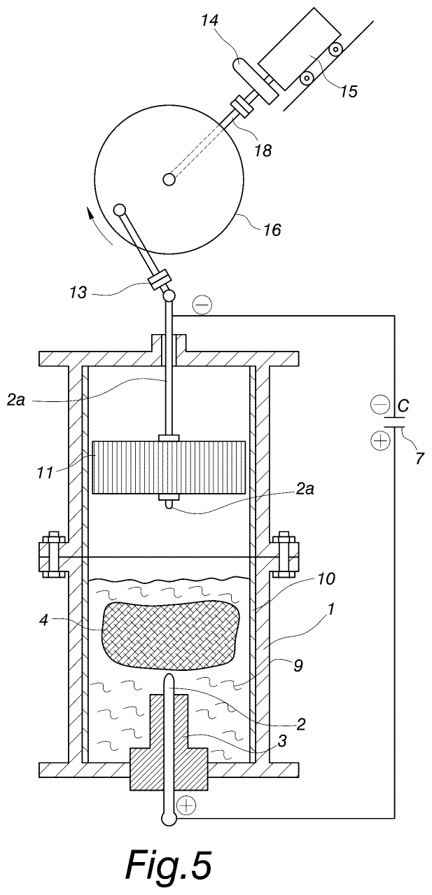

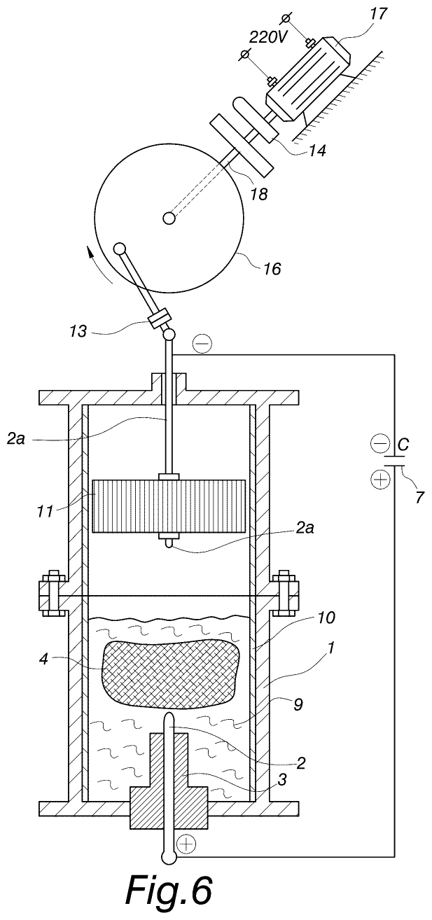

Although the two electrodes (2) and (2a) are pointing toward each other, an electric arc does not occur between them. Both electrodes create a bulk electrical discharge that is beneficial for creating the ball lightning (4). It requires simultaneous switching and creation of ball lightning. The metal electrodes under water are practically not removed, or if they are being moved/demolished, it is over a long period. In addition, the dynamic electrode (2a) can be installed on a piston (11) and will move out during the explosion and in during the implosion. This dual action is the basis of the embodiment shown in FIG. 5 used in the generation of kinetic energy.

FIG. 5 illustrates a schematic of this embodiment. In this case, a more efficient option of simultaneous commutation and creation of ball lightning is used. The dynamic second electrode (2a) is fixed to a movable working piston (11). It protrudes several centimeters downward from the lower surface of the piston. When the piston is in the upper position, the movable electrode is not in contact with the liquid medium (9). When the automation of the process signals to empty the capacitors, the flywheel (16) shoots down the piston and the electrode (2a). The movable electrode is immersed in the liquid medium (9), making electrical contact between the positive and negative electrodes. The ball lightning (4 occurs in the liquid electrolyte in the space between the two point electrodes (2) and (2a).

The core of the ball lightning “eats” the space at the place of its appearance. This happens almost instantaneously, in a millionth of a second. A zone of enormous pressure is created around the ball lightning. The piston ends up in close proximity to the ball lightning core (the core is lighter than the environment; in fact, its internal volume is zero and there is no substance below its surface), and it rushes upward at great speed. Theoretical analyses and practical observations show that if the surface of the piston is covered with a layer of glass or other vitreous material, enamel, it is not possible for the ball lightning core to touch the surface of the piston. The temperature of the core is enormous, several tens of thousands of degrees. Without a coating, the piston can wear out quickly, despite the fact that the life of ball lightning is very short, a few milliseconds.

The piston is connected to a mechanism that converts the kinetic energy of sequential movement into rotary motion, as in internal combustion engines. The pulsed electric current is electrically isolated from the rotary motion mechanism by means of a good electrical isolator (13). The power of the capacitors, the process automation, and the speed reducers (14) can be selected to provide the favorable operating mode of a fuelless engine (15). These quantum engines are absolutely environmentally friendly; they do not use chemical or nuclear fuel, are simple to operate, and are cheap. They are suitable for all land and water vehicles.

FIG. 6 shows another embodiment of such a generator. It is different from the previously presented quantum kinetic engine, FIG. 5. Instead of being a transport consumer of the kinetic quantum energy, the rotary motion system is attached to an electric generator (17). Due to the pulse nature of the quantum energy generated from the ball lightning, the presence of a damper of kinetic energy, the flywheel (16) is necessary. In this implementation, the use of suitable the speed reducers (14) can ensure the necessary mode of operation of the electric generator. The same applies to the transport option.

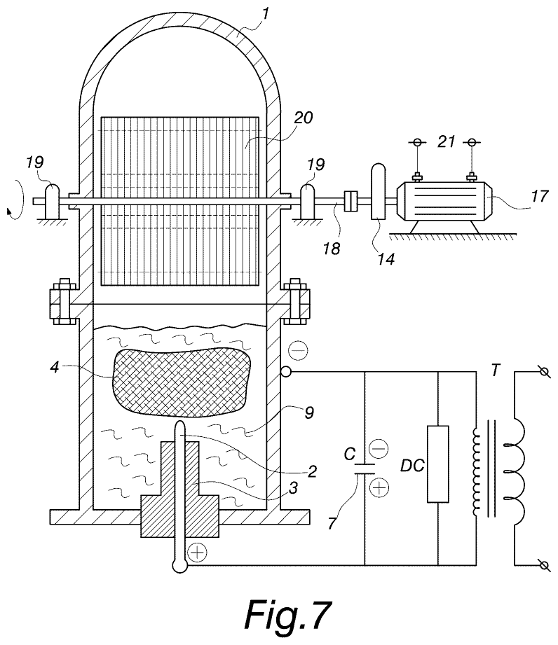

FIG. 7 shows another embodiment of a quantum generator (1) powered by the kinetic quantum energy of the formation of ball lightning (4). In this embodiment, the steam of the liquid medium (9) is fed to a tesla turbine (20). It also uses a rotary turbine action converted to electricity by an electrical generator (17) through the speed reducers (14).

The tesla turbine (20) can be any turbine, although due to the tremendous pressure of the water “shot” by the ball lightning on the propellers, the most suitable turbine that can be used is the Tesla turbine shown in FIG. 4. The advantage of the tesla turbine (20) is that the initial shock of the water jet is absorbed simultaneously by many disks, so the turbine is not damaged. Another possible turbine can be solid discs with significant inert mass to preserve the momentum.

On the other hand, the efficiency of converting the kinetic energy of the jet into the useful energy of rotating the shaft (18) is significantly greater than that of any other mechanism for converting quantum energy into useful energy, and it can reach 100%. Moreover, much of the heat energy of the heated water from the water jet (heated by contact with the very hot core of the ball lightning) is absorbed as kinetic energy of rotation of the turbine shaft in the very close contact and friction between the molecules of the water jet and turbine discs.

The water layer between two adjacent disks is very thin, approximately 2.3 mm, which enables a greater number of water molecules to contact the metal disks of the Tesla turbine and transfer their energy (energy of sequential movement and thermal chaotic energy) to the shaft (18). The shaft (18) is attached to stationary roller bearings (19). The passage of the water jet through the turbine cools the water. It is even possible that the efficiency of energy transformation in the Tesla turbine exceeds 100%. In this way, the output kinetic power/energy from the generator can be transformed into electrical power/energy through the speed reducers (14) and the electric generator (17).

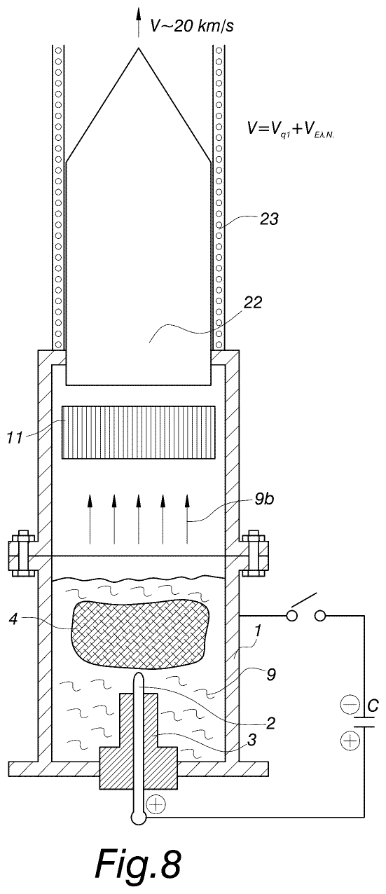

Another embodiment of the invention is shown in FIG. 8. The initial acceleration/velocity of a projectile/missile (22) is launched by the piston (11) moved by the water jet as a result of the accelerated jet stream (9b). It is possible that this speed will exceed the speed required to get a projectile out of the gravitational pull of the Earth. Or, if an electromagnetic device (23) is added to rapidly accelerate a projectile around the barrel, the sum of the two velocities can reach enormous values. The projectile can be made out of strong magnetic alloys such as a neodymium or samarium cobalt alloy.

FIG. 8 shows a schematic illustration of a hyper-velocity rocket/projectile launcher. The initial acceleration of the projectile is created using the quantum energy created by the lightning core of the ball lightning; the piston (11) imparts this enormous kinetic energy to the projectile/missile. After the projectile (22) enters the zone of action of the electromagnetic device (23) (which happens in milliseconds), it is further accelerated by the electromagnetism of the barrel. Finally, the projectile flies out of the barrel of the cannon at an incredible speed, tens of km/second. This quantum kinetic/electromagnetic cannon can economically launch very heavy projectiles/missiles into space at a rate unachievable by conventional methods used now.

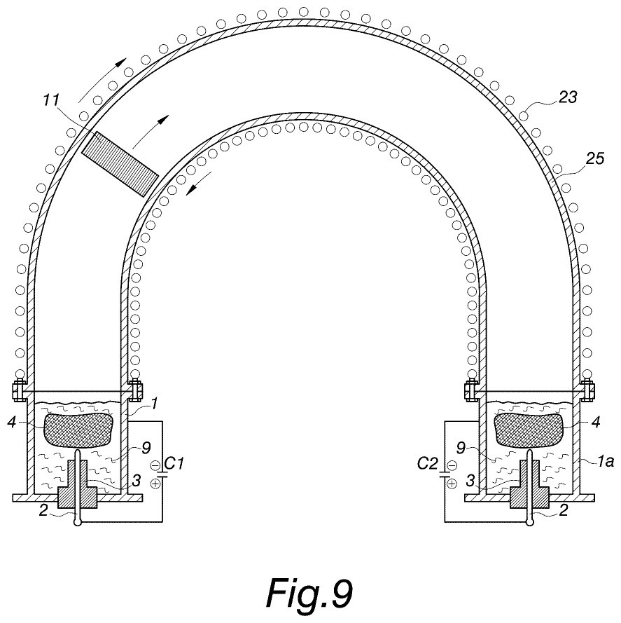

FIG. 9 shows another embodiment of the quantum energy generation method considered in the invention. The closed metal chambers (1) (hereinafter referred to as the first closed metal chamber in FIG. 9) and the closed metal chamber ((1a)) (Hereinafter referred to as the second closed metal chamber in FIG. 9) are connected to a ballistic tunnel (25) into which a heavy and strong permanent magnet alloy (24) (preferably a neodymium magnet) is fired. When the magnet reaches the second chamber (1a), the second battery of capacitors (C2) is preferably charged for a shot.

If not, then a sensor for reaching the maximum allowable charging voltage of the capacitor bank gives a signal to empty the capacitors when they are already charged. The maximum height in the ballistic tunnel is selected so that when the neodymium projectile (24) arrives at this highest point, it still has enough kinetic energy to overcome it and move downward by inertia (using gravity) to the other chamber. Naturally, the withdrawal of electromagnetic energy from the conductive spiral, for example, the electromagnetic device (such as a copper spiral) (23) around the tunnel slows down the speed of movement of the magnetic projectile.

A schematic illustration of an apparatus/system for generating quantum electrical energy in another aspect is shown in FIG. 9. A neodymium magnet (24) moves in a tunnel with a ballistic tunnel (25). At both ends of the tunnel, there are two independent chambers for the generation of ball lightning. This configuration of the apparatus allows it to make full use of the kinetic quantum energy generated by the ball lightning and the energy of gravity. Also, it is the most economical solution for large capacities.

The neodymium magnet (or other strong permanent magnet) (24) moves at high speed in a tunnel with a copper sheath around the tunnel. Shot from the first chamber (1) under the influence of the strong jet of liquid electrolyte, the magnetic projectile moves at a huge initial speed—several km/sec.—moves in the electromagnetic tunnel 23-25 and transmits its kinetic energy to the copper spiral (23), which converts it into electrical energy.

Due to the action of the gravitational force opposite to the motion of the projectile, the velocity of the projectile decreases and can reach zero. To prevent this and direct the projectile gravitationally to the second chamber ((1a)), the dimensions of the tunnel are calculated so that at the highest point of the ballistic tunnel (25), the neodymium magnet (24) has some speed sufficient to bring it into the descending part of the tunnel. There, the projectile picks up speed again, produces electrical energy again, and finally reaches the second chamber (1a). The capacitors and automation must be selected so that at the moment when the projectile magnet reaches the second chamber ((1a)), the capacitors of this chamber are fully charged and ready to launch the projectile in the opposite direction. In this way, time is saved and the output quantum energy is maximized.

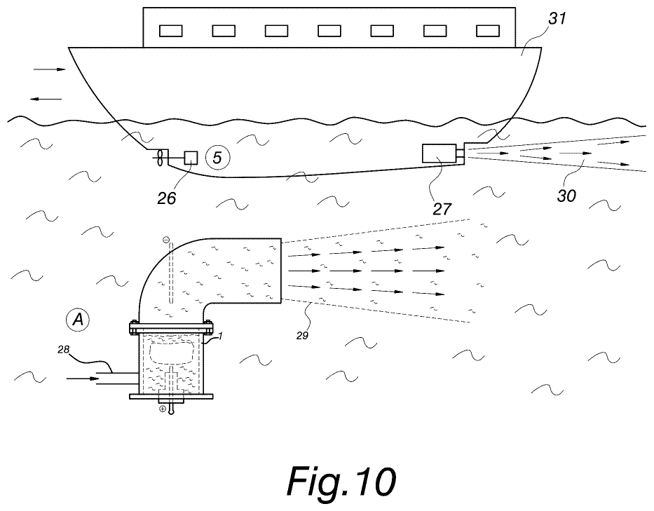

FIG. 10 illustrates another embodiment of a method for moving vessels (boats, ships) in a water environment using the pressure created by ball lightning. When ball lightning occurs in the first chamber (1), which is open from above, the pressure created as a result of the “cutting” of the space at the place of occurrence of the ball lightning exerts for a very short time (2-6 milliseconds) a very strong pressure on the liquid electrolyte in the first chamber (1) (sea water).

Through the opening of the chamber, a strong pressure wave is injected, which pushes the sea vessel in the opposite direction of this wave. As it moves away from the vessel, its internal pressure drops as a result of the transfer of its kinetic energy to the surrounding seawater. If the impulses of the discharge current are frequent (2-3-4 seconds), then there is an overlap of the pressure waves, which makes the movement of the vessel uniform and comfortable, without periodic unpleasant jolts. It is a fuel-less quantum motor for marine vessels.

The quantum generator (27) with the first chamber (1) has a non-return valve (28) allowing the electrolyte to flow in only one direction. If the piston (11) is used, then the non-return valve (28) is installed above the piston, allowing water to fill the top side of the first chamber (1) to create the jet stream (29) and (30). In general, when a piston is used, the electrolyte in the first chamber (1) does not need to be changed, and the fluid above the piston may not need to be an electrolyte. To provide smooth jet action, more than one chamber can be used, with each chamber timed sequentially.

A propeller (26) can be installed in the bow of the ship to take a small portion of the quantum kinetic energy produced by the ball lightning and convert it into electricity. Like a quantum dynamo, it supplies the capacitors with electrical current and all other electrical consumers of electrical current on the ship. In principle, this quantum pressure method can also be used in an air environment.

The shortage of clean drinking water, water for domestic needs and agricultural irrigation is a serious problem for our civilization. And with every passing year, it becomes more serious due to the growth of the population of the planet, the growth of industry and agriculture, and the advancement of civilization in the underdeveloped countries of the world. A large part of the world's population, which lives near the shores of huge bodies of water, seas and oceans, suffers from a lack of water for drinking, washing, and watering agricultural crops.

Conventional methods and equipment have been developed for the desalination of seawater. The biggest obstacle to the widespread use of such conventional seawater desalination plants is the large and very expensive energy consumption, mainly electricity, to create high pressures on the raw water.

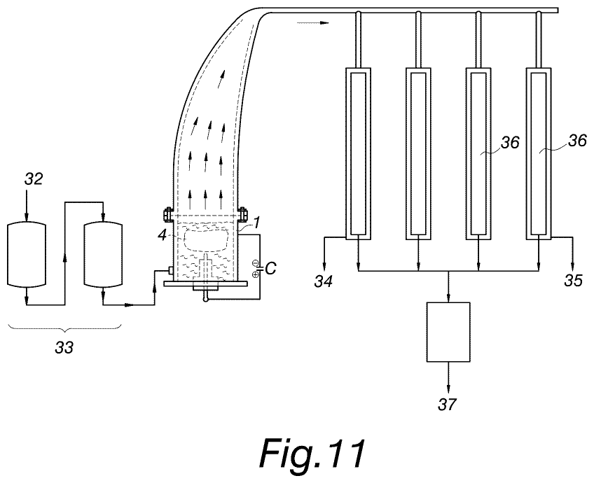

FIG. 11 illustrates such a method. Water pumps, which draw a lot of electricity from the grid, have been replaced by quantum pumps that create very high pressures on processed salty/highly polluted water with practically zero electricity costs.

When the piston (11) is used, the fluid above the piston is separated from the electrolyte in the closed metal chamber (1), and the non-return valve pumps the source of fluid at every implosion cycle. This device can be used for high-pressure pumping in general. The pumped fluid flow can be consistent if multiple chambers are used, and timed in a sequential action, so the fluid flow remains consistent.

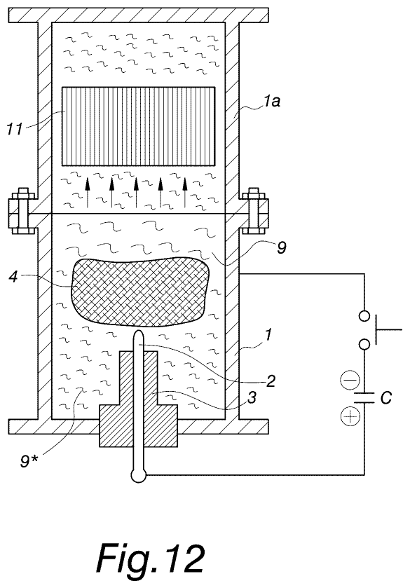

In FIG. 12, another embodiment of the present invention is shown. During the formation of the ball lightning, the liquid medium (9) is highly compressed, and according to the quantum limits shown in FIG. 1, a super-compressed plasma is formed that may reside at the quantum limit for an indefinite time, as long as the compression is maintained. Under such compression, the quantum plasma is a continuous source of thermal energy.

Compression can be achieved by installing a closed metal chamber (1a) on top of the closed metal chamber (1). The piston (11) can be used to create the pressure in the closed metal chamber (1a) to transform the electrolyte, such as seawater, into high-density plasma (9*). That plasma forms around the ball lightning as well but decompresses after the ball lightning disappears.

That is why the piston (11) has a lock to achieve the correct position. After the piston is positioned and the super-dense plasma is formed, the closed metal chamber (1a) can be detached and used as an independent energy source.

Conventional methods of deep compression of gases (up to high pressures of hundreds of atmospheres) require several stages of compression, from small initial pressures to higher pressures at each successive stage. This is a slow and very expensive process using expensive, energy-intensive compressors. Quantum energy solves the problem, as deep compression of gases is done in a very short time, with inexpensive equipment and very little consumption of electrical current.

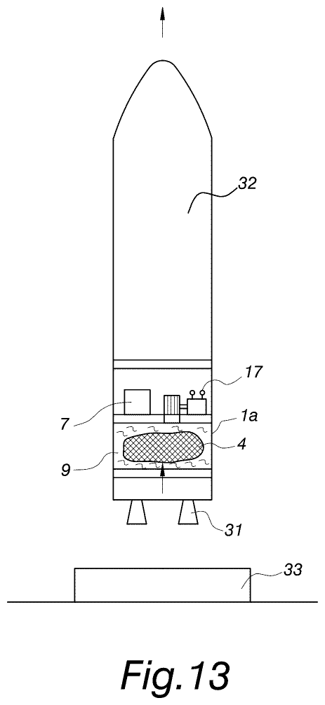

The embodiment shown in FIG. 13 illustrates the launch of heavy material bodies from the Earth's surface into space. When the ball lightning appears in the closed metal chamber (1a) of the experimental generator, the space occupied by the newly created ball lightning is destroyed, and annihilated. As a result of this annihilation, a great amount of pressure is exerted on the liquid medium (9). The liquid electrolyte above the ball lightning is “shot” upward with the speed of a projectile. According to Newton's Third Law, the same opposite force, downward, creates pressure on the concrete floor.

There is also upward movement of the heavy 400 kg chamber. The chamber jumps up at a speed greater than that of a projectile, measured with a very fast camera. The liquid electrolyte beneath the ball lightning core is compressed to a state of super-dense quantum plasma. The source of this super-compression is due to a quantum effect. After the ball lightning disappears, the super-dense plasma is restored to its original liquid state. Like an extremely stretched spring, the liquid electrolyte shoots upward and transfers its energy to the upper surface of the closed metal chamber.

If the vessel chamber (32) is a rocket, hermetically sealed with respect to the external environment, then the strong quantum pulse of the “stretched” quantum plasma-liquid electrolyte is transmitted to the upper (in the direction of motion) side of the rocket and propels it forward. In “hits” with a high frequency of seconds, uniform movement of the rocket forward is ensured.

A fuelless quantum rocket also needs energy to charge the capacitors and energy for internal needs. This energy can be taken from the energy of the super powerful jet of the “stretchable” spring, superdense plasma/liquid electrolyte. The efficiency of the process can reach tens and hundreds of times greater than that of conventional methods. That is, there is no problem producing large amounts of energy to power the rocket. Thus, this method of rocket propulsion requires no fuel or a supply of matter to create a jet of motion.

As an option for launching very heavy rockets, a ground installation can be used for an initial powerful impulse. The propulsion creates an impulse in a single direction, allowing forward movement or levitation of the heavy object. It works on the same principle: hundreds or thousands of capacitors (e.g., capacitors with 200 MF and a voltage of 50 kilovolts) provide the necessary energy for the creation of an extremely powerful ball lightning capable of creating an initial speed of movement of the rocket even greater than the speed necessary to overcome Earth's gravitational pull and take the rocket into open space. Then, the rocket can propel itself with its own quantum fuelless generator.

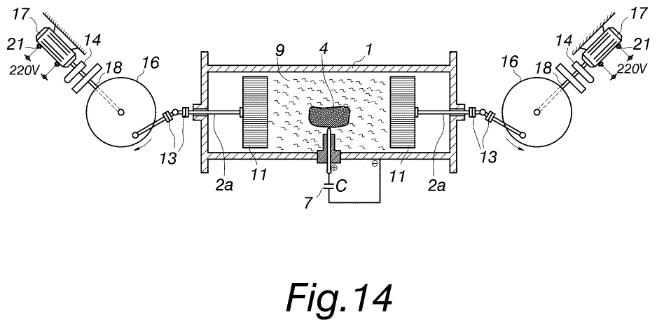

The embodiments presented above use only 50% of the energy due to the construction of the closed metal chamber (1). They have been presented to illustrate various industrial implementations of the quantum object. In FIG. 14, a new embodiment is presented where the closed metal chamber (1) has a round cylindrical design with two pistons (11) that harvest the kinetic energy of the quantum object in two possible directions. Also, a similar concept with a four-pistons design can be constructed. This utilization can harvest up to 100% of the energy produced by ball lightning.

In FIG. 14, the closed metal chamber 1 (such as an isolated positive electrode) is a negatively charged cylindrical body filled with the liquid medium (9) between the two pistons (11), connected to flywheels (16) through piston assemblies, including shafts (2a) and isolators (13). In addition, it is connected to an electrical generator (17) through a shaft (18) and a speed reducer (14), converting the kinetic energy into electrical power.

The liquid medium (9) is the medium that forms the conditions for the ball lightning, preferably seawater or similar. During the discharge of the capacitor (7) through the electrode, a ball lightning is formed that compresses the electrolyte, forming quantum plasma and pushing the pistons out. After a few milliseconds, the ball lightning disappears and further creates an implosion, restructuring the electrolyte back to its original state and pulling the pistons back to their original position. In this embodiment, the pistons are driven in both directions compared to a conventional ignition engine where the ignition force is only in one direction. This increases the efficiency of the process to 100%.

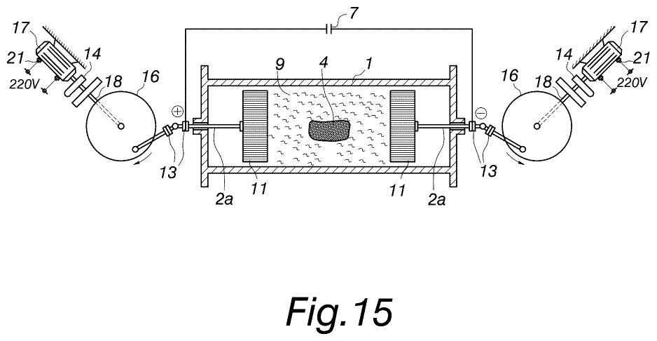

The embodiment shown in FIG. 15 includes two oppositely charged electrodes installed on the pistons connected to the opposite sides of the charged capacitor (7). In this invention, an initial charge of the capacitor (7) creates the ball lightning (4). The discharged energy from the ball lightning is properly rectified and harvested back into the capacitor (7) for the next discharge. The conductivity of the electrolyte changes during expansion and contraction.

In all the embodiments above, the authors of the present invention outlined the benefits of using an artificially created quantum macro-object that creates highly efficient kinetic, thermal, and electric output utilized in various practical cases.

1. An apparatus for creating an artificial ball lightning comprising:
a metal chamber including an electrode with opposite polarity, wherein the electrode is installed in the metal chamber and electrically isolated from it;
an electrolyte, resides in the metal chamber;
an energy source, provide high voltage and high current for a very short time;
a switch, connected to the energy source, withstand high voltage and high current;
a ball lightning formed in the metal chamber from the discharge of the energy source in the electrolyte.

2. The apparatus of claim 1, wherein the energy source is a first capacitor, is charged with a line transformer through a rectifier and a high voltage switch.

3. The apparatus of claim 1, wherein the metal chamber is made of stainless steel, glass, quartz, or material resistant to aggressive environments and capable of withstanding high pressures: wherein the stainless steel is coated with glass, quartz, ceramic, or low conductive high heat coating.

4. The apparatus of claim 1, wherein the electrode is made from copper, tungsten, or conductive high temperature material and placed in an electrically isolated part.

5. The apparatus of claim 1, wherein there is at least one second battery/capacitor of higher or similar capacity to the first capacitor and a high voltage switch to allow collecting the reversed energy.

6. The apparatus of claim 5, wherein the second capacitor is connected to the first capacitor with a charging circuit, wherein the charging circuit charges the first capacitor before forming the ball lightning.

7. The apparatus of claim 1, wherein the metal chamber is fully filled with an electrolyte, such as sea water with various concentrations.

8. Apparatus of claim 1, wherein there is a second electrode connected to the opposite pole of the capacitor/battery.

9. The apparatus of claim 8, wherein the second electrode is connected to a pneumatic or hydraulic cylinder allowing the second electrode to be inserted and removed from the metal chamber.

10. The apparatus of claim 8, wherein the second electrode is mounted on a piston, wherein that piston contracts and expands with the formation of the ball lightning.

11. The apparatus of claim 10, wherein two pistons are used to harvest the kinetic energy in two directions.

12. An apparatus for creating an artificial ball lightning comprising:
a metal chamber including an electrode with opposite polarity, wherein the electrode is installed in the chamber and electrically isolated from it;
an electrolyte, resides in the chamber;
an energy source, is a battery of high voltage or high energy capacitors,
wherein the energy source provide high voltage and high current for a very short time;
a second electrode mounted on a piston, wherein that piston contracts and expands with the forming of the ball lightning;
a ball lightning formed in the metal chamber from the discharge of the capacitor in the electrolyte.

13. The apparatus of claim 12, wherein the chamber and the piston are made of stainless steel and coated with glass, enamel, quartz, ceramic, or low conductive high heat coating to repel the ball lightning.

14. The apparatus of claim 12, wherein the second electrode is electrically separated with an insulator from the system and transforms the sequential movement of the piston into rotary movement.

15. The apparatus of claim 12, wherein the transforming system has a flywheel for accumulating kinetic energy and a gearbox to achieve the necessary revolutions of the shaft.

16. The apparatus of claim 12, wherein the rotary movement of the shaft is transmitted to a rotor of an electric generator through a shaft and a flywheel.

17. The apparatus of claim 12, wherein the electric generator produces electrical energy used to charge the capacitors and other service needs of the pulse generator.

18. The apparatus of claim 12, wherein chamber 1 is connected to a Tesla turbine, wherein the Tesla turbine or similar turbine converts the linear electrolyte movement to rotary momentum.

19. The apparatus of claim 12, wherein the metal chamber is connected to a barrel, wherein the barrel used to shoot projectile.

20. The apparatus of claim 12, wherein the metal chamber is connected to a barrel, wherein the barrel has an electrical induction mechanism to accelerate and/or rotate the projectile during the shot.

21. The apparatus of claim 12, wherein the barrel can shoot projectiles made of strong magnetic materials such as neodymium, samarium cobalt alloy.

22. The apparatus of claim 12, wherein the metal chamber is duplicated and connected with a tunnel covered with a conductive spiral that generates an induction current by shooting a highly magnetized alloy through the tunnel.

23. The apparatus of claim 12, wherein the metal chamber is connected to a removable chamber, wherein the piston has a locked position to remain in a high position after compressing the electrolyte to a high density, forming a compressed plasma.

24. The apparatus of claim 12, wherein the metal chamber has a non-return valve, wherein the non-return valve injects fluid to create a single jet stream.

25. The apparatus of claim 12, wherein the metal chamber has a non-return valve and is multiplied and timed with other chambers to create a continuous jet stream.

26. The apparatus of claim 12, wherein the metal chamber has a non-return valve, and is used to pump fluid into a fluid flow system.

27. The apparatus of claim 12, wherein the metal chamber is used to create propulsion opposite to the inertia of the fluid, wherein that propulsion creates an impulse in a single direction that allows forward movement or levitation.

28. The apparatus of claim 12, wherein at least two pistons are used with two oppositely charged fully enclosed electrodes.
